(19) United States
(12) Patent Application Publication
(10) Pub. No.: US 2016/0031727 A1
(43) Pub. Date: Feb. 4, 2016

(54) WASTEWATER TREATMENT METHOD, MEMBRANE DISTILLATION MODULE AND WASTEWATER TREATMENT APPARATUS

(71) Applicant: SUMITOMO ELECTRIC INDUSTRIES, LTD., Osaka (JP)

(72) Inventors: Atsushi YAMAGUCHI, Osaka (JP); Toru MORITA, Osaka (JP)

(73) Assignee: Sumitomo Electric Industries, Ltd., Osaka-shi, Osaka (JP)

(21) Appl. No.: 14/782,894

(22) PCT Filed: Nov. 26, 2014
(86) PCT No.: PCT/JP2014/081167

§ 371 Date: Oct. 7, 2015

(30) Foreign Application Priority Data
Nov. 27, 2013 (JP) 2013-245452

(51) Int. Cl. C02F 1/44; B01D 71/36; C10G 1/04; B01D 71/32; B01D 63/02; B01D 69/04; B01D 61/36; B01D 71/34

(52) U.S. Cl. CPC C02F 1/447; B01D 61/364; B01D 71/36; B01D 71/34; B01D 71/32; B01D 63/02; B01D 69/04; C10G 1/047; C02F 2101/32

(57) ABSTRACT

A wastewater treatment method for purifying heated wastewater produced when recovering bitumen from an oil sand layer by an in-situ recovery method for reuse as steam is provided. The method includes extracting bitumen from a bitumen-mixed fluid recovered by injecting high-temperature steam into the oil sand layer, and subjecting separated heated wastewater to membrane distillation using a hydrophobic porous membrane provided in a membrane distillation module to recover treated water from which an oil component, a salt component, and an organic matter contained in the heated wastewater have been reduced/removed.

### TECHNICAL FIELD

The present invention relates to a wastewater treatment method, a membrane distillation module used for the wastewater treatment method, and a wastewater treatment apparatus including the membrane distillation module, which are suitably used particularly for treating heated wastewater separated from bitumen when producing bitumen from oil sands by an in-situ recovery method.

### BACKGROUND ART

Recently, attention is being given to bitumen recovered from Canadian oil sands as valuable petroleum resources. As a method of producing bitumen from the oil sands, technical development of the in-situ recovery method, such as the SAGD (Steam Assisted Gravity Drainage) process or the CSS (Cyclic Steam Stimulation) process, is being promoted.

According to the in-situ recovery method, high-temperature steam is injected into high-viscosity oil in an oil sand layer, in which the oil does not flow at a normal temperature, to reduce the viscosity of oil by heating. Then, a bitumen-mixed fluid is recovered, and bitumen is extracted from this heated bitumen-mixed fluid. Therefore, “water” for producing a large amount of high-temperature steam is required. In order to produce steam, the SAGD process requires water of about three times or more as much as the amount of oil produced. Meanwhile, in Canada, the amount of water intake that is allowed to use is limited by the environmental standards. Therefore, recycling of the heated wastewater is indispensable.

In order to produce high-temperature steam necessary for producing the bitumen, the applicant of the present application provides a technique for recycling the heated wastewater in Japanese Patent Laying-Open No. 2010-248431 (PTD 1).

In this process, heated wastewater after separating bitumen from a heated bitumen-mixed fluid is treated by membrane filtration using a microfiltration membrane (MF membrane) made of PTFE (polytetrafluoroethylene). The treated water is subjected to desalination and softening through distillation by a hardness component removal device, such as a lime softener or a weak acid cation softener, or by an evaporator. The distilled water is heated and reused as steam in recovering bitumen from oil sands.

Japanese Patent Laying-Open No. 2010-248431 provides the following advantages. First, since a membrane filter made of PTFE having excellent heat resistance and chemical resistance is used, heated wastewater can be purified by filtering through the membrane filter without lowering the temperature of the heated wastewater, which can reduce heat loss. Secondly, since the heated wastewater can be reproduced as high-temperature treated water, heating energy in a boiler when reusing the heated wastewater as high-temperature steam can be reduced. Furthermore, since a strong alkaline cleaning solution can be used for cleaning in order to remove an oil component adhering to the surface of the membrane filter, filter performance can be maintained.

### CITATION LIST

### Patent Document

PTD 1: Japanese Patent Laying-Open No. 2010-248431

### SUMMARY OF INVENTION

### Technical Problem

However, in microfiltration in which wastewater permeates through holes of a fine membrane filter, the holes may be blocked depending on the size of solid materials and the viscosity of the oil component, so that occurrence of clogging cannot be prevented, resulting in a risk of reduced permeate flow rate. Moreover, soluble organic matters, such as naphthenic acid which is a low molecule organic matter, cannot be removed with the membrane filter.

Furthermore, since a salt component and a hardness content dissolved in water have not been removed from the treated water obtained by membrane filtration, the treated water needs to be subjected to desalination and softening through distillation by (1) a hardness component removal device, such as a lime softener or a weak acid cation softener, (2) an evaporator or the like, prior to heating by a boiler to produce steam. Therefore, problems arise in that increase in equipment costs cannot be restrained, and in that a trouble is likely to occur in which organic matters and an oil component adhere to the inside of the evaporator during distillation by the evaporator.

The present invention was made in view of the above-described problems, and has an object to provide a wastewater treatment method of purifying heated wastewater containing an oil component, a salt component, organic matters, and the like produced when recovering bitumen from oil sands by the in-situ recovery method for reuse as steam, wherein the wastewater containing these many types of contaminants can be treated rationally and can be reused without adopting such a process as membrane filtration by which occurrence of clogging cannot be avoided, distillation for desalination and the like.

### Solution to Problem

To achieve the above-described object, according to the present invention, as a first invention, a wastewater treatment method for purifying heated wastewater produced when recovering bitumen from an oil sand layer by an in-situ recovery method for reuse as steam is provided. The method includes extracting bitumen from a heated bitumen-mixed fluid recovered by injecting high-temperature steam into the oil sand layer, and subjecting separated heated wastewater to membrane distillation using a hydrophobic porous membrane provided in a membrane distillation module to recover treated water from which an oil component, a salt component, and an organic matter contained in the heated wastewater have been reduced/removed.

The hydrophobic porous membrane is suitably implemented by a hydrophobic fluororesin porous membrane, and among others, an expanded PTFE porous membrane superior in water repellency and heat resistance.

As described above, the present invention features applying membrane distillation to treatment of heated wastewater containing a large amount of oil component, salt component and organic matters produced when recovering bitumen from oil sands.

Adopting the wastewater treatment method of the present invention, equipment and steps for producing bitumen from oil sands by the in-situ recovery method implemented by the SAGD process or the CSS process can be reduced significantly, and environmental problems can also be reduced significantly. In particular, since heated wastewater produced in the step of extracting bitumen from oil sands has a high temperature at which steam is produced without being heated, heating of wastewater required in membrane distillation is unnecessary, which can reduce running costs.

While PTD 1 adopts the microfiltration process as the process for purifying heated wastewater produced when recovering bitumen from oil sands, the present invention adopts a membrane distillation process in which raw water (wastewater) and treated water are isolated implementing the membrane by a hydrophobic diaphragm to only allow steam to permeate therethrough without allowing water to permeate therethrough. Therefore, with the membrane distillation, minute foreign matters can be removed by isolating similarly to microfiltration, and a salt component, organic matters containing naphthenic acid, and the like, which are dissolved components that cannot be removed with a membrane filter can also be removed. Therefore, desalination and softening through distillation by a hardness component removal device or an evaporator that is required in PTD 1 after filtration treatment can be eliminated.

Preferably, the heated wastewater held at 60° C. to 200° C. is flown to one surface side of the hydrophobic porous membrane (hereinafter abbreviated to a distillation membrane) at a pressure A by a pump, and cooling water held at 5° C. to 40° C. is flown on the other surface side at a pressure B by a pump, wherein a relation of pressure A<pressure B is met.

Accordingly, even if the function of the distillation membrane is impaired by some abnormality, wastewater does not flow into the treated water side if pressure B on the treated water side is higher. The water quality can thereby be maintained.

The membrane distillation only allows steam produced from heated wastewater to permeate through holes of the distillation membrane, using the temperature difference and saturation vapor pressure difference between fluids flowing on the both sides of the distillation membrane implemented by a hydrophobic porous membrane as driving sources. As the temperature difference increases, the saturation vapor pressure difference increases, allowing membrane distillation to be performed efficiently. Therefore, membrane distillation from the heated wastewater side to the cooling water side can be performed more efficiently as the heated wastewater has a higher temperature and the cooling water has a lower temperature.

Steam permeated through the membrane is cooled to be liquefied. This liquefied treated water (i.e., cooling water) is transported to the outside of the system for reuse as high-temperature steam. It is therefore essentially preferable not to lower the temperature of the cooling water. In order to liquefy the steam permeated through the distillation membrane, however, cooling is necessary. Preferably, the temperature of the cooling water has a temperature in the range of 5° C. to 40° C.

On the other hand, heated wastewater has a high temperature of 60° C. to 200° C. as it is obtained by separating bitumen from a heated bitumen-mixed fluid. Thus, even if the heated wastewater is supplied to the distillation membrane without being subjected to heat treatment, a temperature difference from the cooling water can arise. When the temperature of the heated wastewater is lower than the required temperature in the range of 60° C. to 200° C., it is preferable to heat the wastewater using inexpensive heat energy, such as solar heat or heated effluent.

It is preferable that the heated wastewater has a higher temperature as described above. If the temperature exceeds 100° C., however, the wastewater itself boils at atmospheric pressure. Then, hot compressed water will be supplied. This is not desirable in that a water bearing pressure limit value of the distillation membrane needs to be set high, and in that the facility will be expensive because of safety measures for increasing pressure resistance of a piping material and the like. Thus, in order to set the temperature of wastewater at 100° C. or below and to reduce the pressure, it is more preferable to store heated wastewater in a reservoir (tank) exposed to the atmosphere.

The treated water having been subjected to membrane distillation contains each of the oil component, the organic matter including naphthenic acid, and the salt component by less than 1 mg/l, which is very little.

It is expectable that the quality of treated water, namely, the increment relative to “an analysis value of aqueous concentration of each substance in circulating cooling water in the treatment initiation stage” becomes at least less than 1 mg/l, further less than 0.1 mg/l, or less than or equal to a detection limit. Since the salt component can also be removed together with the oil component as described above, the treated water having been subjected to membrane distillation can be reheated by a heating device to produce high-temperature steam, without experiencing desalination and hardness removal steps, and the steam can be injected into a high-viscosity oil in the oil sand layer to be reused in recovery of bitumen.

As described above, according to the present invention, since a hardness component and a salt component are removed together with the oil component and organic matters through membrane distillation, desalination and softening steps by a hardness component removal device, an evaporator or the like required in PTD 1 can be eliminated. The cooling water having been subjected to membrane distillation can be heated by an inexpensive general-purpose drum-type boiler, rather than by a special boiler to produce steam for reuse in bitumen recovery.

That is, according to the present invention, the treated water having been subjected to membrane distillation is reheated by a drum-type boiler to obtain high-temperature steam, without a distillation apparatus, such as a hardness removal device or an evaporator interposed therebetween, and the high-temperature steam is injected into a high-viscosity oil in the oil sand layer to be reused for recovering bitumen.

Furthermore, for a stable operation of the apparatus of the present invention, it is preferable to discharge the heated wastewater and cooling water from the membrane distillation module during stop of circulation of the heated wastewater and cooling water, and thereafter to blow dry air to reduce the humidity in the membrane distillation module, thereby preventing condensation from occurring in the membrane.

As a second invention, a membrane distillation module for use in the wastewater treatment method of the first invention is provided. An oil-repellent layer is provided at least on a surface of the hydrophobic porous membrane made of fluorine-based resin to be in contact with the heated wastewater.

Preferably, according to the present invention, in order to treat heated wastewater, the hydrophobic porous membrane is made of PTFE (polytetrafluoroethylene), PVDF (polyvinylidene difluoride), or PCTFE (polychlorotrifluoroethylene), and made of fluorine-based resin having heat resistance whose practical maximum operating temperature exceeds 100° C.

The melting point serving as an index of heat resistance is 327° for PTFE, 155° to 175° for PVDF, and 220° for PCTFE. The angle of contact with water serving as an index of water repellency thereof is 114° for PTFE, 82° for PVDF, and 84° for PCTFE. Therefore, when oil-containing wastewater to be treated has a high temperature of 60° C. to 200° C., PTFE is particularly desirable.

In particular, the PTFE has chemical resistance, particularly alkali resistance and oxidation resistance. In order to remove an oil component, organic matters and the like adhering to the surface of the distillation membrane in contact with heated wastewater, they need to be removed by dissolution or stripping by chemical cleaning with a strong alkaline aqueous solution, a hydrogen peroxide solution or the like, so that the wastewater is reproduced repeatedly. Therefore, alkali resistance and oxidation resistance are important physical properties, and a PTFE membrane having these properties allows treatment performance to be maintained over a longer period of time.

As described above, the expanded PTFE membrane is used most suitably because of its excellent heat resistance, strength and cleaning chemical resistance. Preferably, the porous membrane made of the expanded PTFE has a form of (1) a hollow fiber membrane, (2) a tubular porous membrane obtained by winding a porous sheet and securing wound ends by sealing to represent a cylindrical shape, or (3) a bag-like composite membrane obtained by sealing, such as by heat sealing, both ends of two porous membranes laminated on both surfaces of a dissimilar material, such as a nonwoven fabric, a flow path material, such as a net, being included on the inner side of the composite membrane.

Preferably, the hydrophobic porous membrane used for the membrane distillation is implemented by (1) a hollow fiber membrane, (2) a tubular porous membrane or (3) the composite membrane, wherein in the hydrophobic porous membrane, a circulative path for the heated wastewater is provided on the outer peripheral surface on which an oil-repellent layer is provided, while a hollow portion surrounded by the inner peripheral surface serves as a circulative path for the cooling water.

The expanded PTFE membrane itself in the form of (1), (2) or (3) is set to have an average hole diameter of 0.01 μm to 1 μm, has a high porosity of 40% to 90%, preferably 65% to 85%, and more preferably 70 to 80%. The reason for setting the porosity as described above is as follows: a membrane having a higher porosity is desirable in terms of steam permeability because the diffusion resistance is lower, and the treating speed is faster. As to holding of an oil repellent agent, higher porosity results in a larger specific surface area, and hence a larger holding force, by which stable holding is easier to achieve.

When the hollow fiber membrane (1) is adopted, it is preferable to set the inner diameter at 0.5 mm to 10 mm, and the thickness at 0.3 to 1 mm. When the tubular porous membrane (2) is adopted, it is preferable to set the inner diameter at 3 mm to 20 mm, and the thickness at 30 μm to 1 mm. The composite membrane (3) preferably has a thickness of 10 μm to 5 mm.

The hollow fiber membrane (1), the tubular porous membrane (2) or the composite membrane (3) made of the expanded PTFE porous material desirably has a high strength. As for the strength, it is preferable that a tensile strength at 25° C. be more than or equal to 30N, preferably more than or equal to 50N, and the upper limit is about 150N.

The tensile strength was in conformity with JIS K 7161, and the hollow fiber membrane itself was used as a test piece. Measurement was performed setting the pulling rate during the test at 100 mm/min and the gauge length at 50 mm. Accordingly, when the tensile strength is set at more than or equal to 30N, a highly reliable operation is also possible in membrane distillation always operated at high temperature, over a long period of time without leakage that would be caused by membrane cracking and the like.

Because of the chemical resistance, even if a high-concentration alkali cleaning solution or an oxidation-resistant cleaning solution is repeatedly used, the membrane will not degrade in treatment capacity and strength, and a high-performance purifying function can be maintained over a long period of time.

In particular, it is desirable to provide an oil-repellent layer at least on the surface of the hydrophobic porous membrane made of the expanded PTFE porous material or the like to be in contact with heated wastewater and to provide the oil-repellent function. Since providing the oil-repellent function leads to a property of even repelling a soluble organic matter, a surface active agent, a solvent, and an organic component, such as an oil component, particularly contained in wastewater, it is possible to prevent contamination due to their adhesion to the membrane which would cause moistening of the membrane, thereby providing stable membrane distillation performance without moistening the membrane over a long period of time.

The oil-repellent function means that, for example, when a hollow fiber membrane is immersed in 100% n-hexane for impregnation, hexane does not enter holes in the membrane surface visually, that is, the membrane is not moistened. By another index, it means that the rate of change in ventilating performance of the membrane does not substantially vary.

In the oil-repellent layer provided on the surface of the hydrophobic porous membrane, a polymer having a fluorinated alkyl side chain is preferably held in the hydrophobic porous body.

A method that can be adopted as a method for providing the oil-repellent layer on the surface of the hydrophobic porous membrane is to impregnate a porous membrane with a solution by a technique of preparing the solution in which a fluorination monomer or further a polymerization initiator has been dissolved, and immersing a porous membrane in that solution, or a technique of forming a module by a porous membrane, and then injecting this solution into the porous material, and then to remove the solvent by volatilization. In implementation, by dissolving a monomer and then diluting it with a solvent to set the concentration properly, a proper amount can be held without a porous portion being clogged. On the other hand, at least one of the surfaces of the hydrophobic porous base membrane is impregnated with a solvent containing a proper concentration of a substance having already become a polymer dissolved therein or the solvent is applied to the one surface, and then dried, or the above-mentioned substance is deposited with a poor solvent. The oil-repellent layer can also be obtained by carrying out this step after forming a membrane module.

As described above, since the distillation membrane used in the present invention has the oil-repellent layer provided on the surface of the hydrophobic porous membrane, a large amount of oil component contained in heated wastewater separated from a heated bitumen-mixed fluid can be reduced/prevented from adhering to the surface of the distillation membrane. As a result, troubles, such as performance degradation that would be caused by moistening due to contamination of the membrane and leakage, which are considered as drawbacks of membrane distillation, can be prevented. Moreover, maintenance frequency can be reduced to reduce running costs, and productivity can be improved.

In the hydrophobic porous membrane used for the membrane distillation, a circulative path for heated wastewater may be provided on the outer surface of each of the hollow fiber membrane (1), the tubular porous membrane (2) and the composite membrane (3), and the other side (inner surface) isolated by the membrane may serve as a circulative path for the cooling water.

In the case of the hollow fiber membrane (1) and the tubular porous membrane (2), water can be flown in the reverse direction.

In particular, when treating wastewater containing a large amount of solid content, such as oil sand wastewater, the hollow fiber membrane or the tubular porous membrane has the oil-repellent layer on the outer surface where heated wastewater containing an oil component, a salt component, and organic matters is flown, and steam passes through the hollow portion, which serves as a passage of cooling water produced by liquefied steam. With this structure, the hollow portion is unlikely to be clogged by the solid matter or oil component in wastewater, and the cooling water flows favorably. Thus, a deflection is unlikely to occur, and the temperature difference is made uniform, so that membrane distillation capability can be stabilized ensuring the temperature difference stably.

As a third invention, the present invention further provides a wastewater treatment apparatus including the membrane distillation module of the second invention. A reservoir of the heated wastewater, a pump and a heater are inserted in the circulative path for the heated wastewater. The reservoir is exposed to the atmosphere to lower pressure and temperature relative to raw water of the heated wastewater. The temperature is adjusted by the heater to a required temperature. The heated wastewater is supplied to the outer surface side of the hydrophobic porous membrane by the pump at required pressure A. A cooler, a cooling water tank and a pump are inserted in the circulative path for the cooling water. The temperature of treated water produced from steam having permeated through the hydrophobic porous membrane is adjusted by the cooler and captured into the cooling water tank. Part of the treated water stored in the cooling water tank is supplied to the circulative path by the pump for use in liquefying the steam having permeated through the hydrophobic porous membrane, and the remainder of the treated water is supplied to a supply pipe of a reuse system for recovering bitumen.

### Advantageous Effects of Invention

As described above, according to the present invention, membrane distillation is adopted as a wastewater treatment method for purifying wastewater produced when recovering bitumen from an oil sand layer by the in-situ recovery method and reusing the purified wastewater as steam. Therefore, the salt component can be removed together with the oil component and organic matters, which can eliminate the need for desalination and softening steps by a hardness component removal device, an evaporator or the like which have been required conventionally. Moreover, since the hydrophobic porous membrane used for membrane distillation has an oil-repellent function, moistening-induced performance degradation that would be caused by membrane moistening due to organic matters, a solvent, a surface active agent, and the like, which has been considered as a drawback of membrane distillation can be prevented. Furthermore, clogging that would be caused by the oil component, particles and the like entering the membrane can be prevented, and cleaning of the surface of the hydrophobic porous membrane brought into contact with heated wastewater is facilitated, resulting in ease of maintenance.

### BRIEF DESCRIPTION OF DRAWINGS

FIG. 1 is a flowchart showing a process of producing bitumen from oil sands in which a wastewater treatment apparatus of the present invention is provided.

FIG. 2 shows a membrane distillation module used for the wastewater treatment apparatus shown in the previous flowchart, a vertical sectional view shown at (A), an enlarged perspective view of a hollow fiber membrane shown at (B), and a partially enlarged cross sectional view of an assembled bundle of hollow fiber membranes shown at (C).

FIG. 3 is an overall view of the wastewater treatment apparatus.

FIG. 4 is a perspective view showing a variation of a hydrophobic porous membrane used for the membrane distillation module.

### DESCRIPTION OF EMBODIMENTS

Hereinafter, an embodiment of the present invention will be described with reference to the drawings.

A wastewater treatment apparatus of the present invention includes a membrane distillation module. In the in-situ recovery method for producing bitumen from oil sands, performed by the SAGD process or the CSS process, bitumen is extracted from a heated bitumen-mixed fluid recovered from underground, and heated wastewater separated from the mixed fluid is subjected to purification treatment by membrane distillation using a distillation membrane made of PTFE.

In the present invention, the term “heated” means that the temperature is elevated to be higher than the ambient temperature. The case where the temperature is elevated to be higher than 20° C. if the ambient temperature is about 20° C. is referred to as heating.

The heated wastewater contains 100 to 3000 mg/L of oil component together with a salt component and organic matters, and has a high temperature of 60 to 200° C. This heated wastewater containing oil, salt, and organic matters is subjected to purification treatment through membrane distillation until the oil component, the organic matter including naphthenic acid and the salt component are reduced to be less than 1 mg/l.

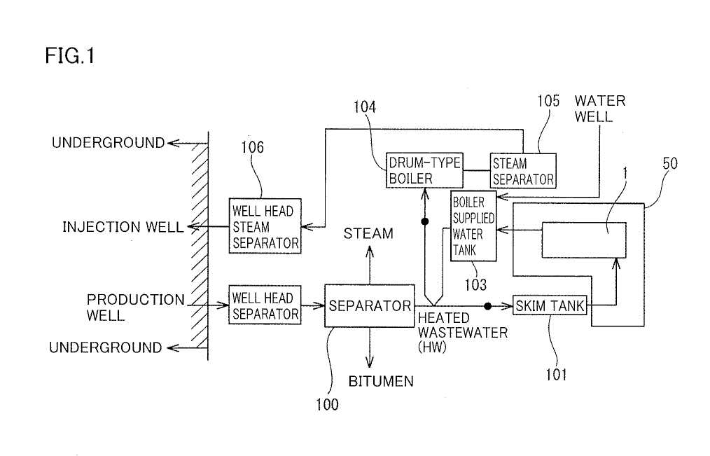

First, a process of producing bitumen by the SAGD process to which wastewater treatment of the present invention is applied will be described based on the flowchart of FIG. 1.

Two horizontal wells are drilled at several meter intervals. A high-temperature and high-pressure steam is injected from the upper-level horizontal well (injection well) to increase the flowability of high-viscosity bitumen in an oil sand layer. A heated bitumen-mixed fluid having reduced viscosity is moved downward to a production well under its own weight to recover the heated bitumen-mixed fluid from the production well.

The recovered heated bitumen-mixed fluid is fed to a separator 100, such as a knock out drum or a treater, and separated into bitumen and heated wastewater HW. Separated heated wastewater HW is contaminated water containing an oil component, a salt component and many organic matters, such as naphthenic acid.

This heated wastewater HW is fed to a skim tank 101 from separator 100, and transferred from skim tank 101 to pass through a wastewater treatment apparatus 50 including a membrane distillation module 1 according to the present invention for purification treatment. Water pumped from a water well is added to this purified treated water (cooling water), and stored in a boiler supplied water tank 103. The stored water is supplied to a drum-type boiler 104 generally used widely for heating. Subsequently, steam separated by a steam separator 105 is injected into the injection well from a well head steam separator 106.

With the conventional apparatus described in PTD 1, a microfiltration apparatus made of an MF membrane is provided as a wastewater treatment apparatus. After the microfiltration, wastewater is subjected to hardness removal by a plurality of apparatuses, and then supplied to a boiler supplied water tank.

The present invention eliminates the need for the evaporator, and supplies the treated water treated by wastewater treatment apparatus 50 to boiler supplied water tank 103.

Wastewater treatment apparatus 50 including membrane module 1 will be described in detail.

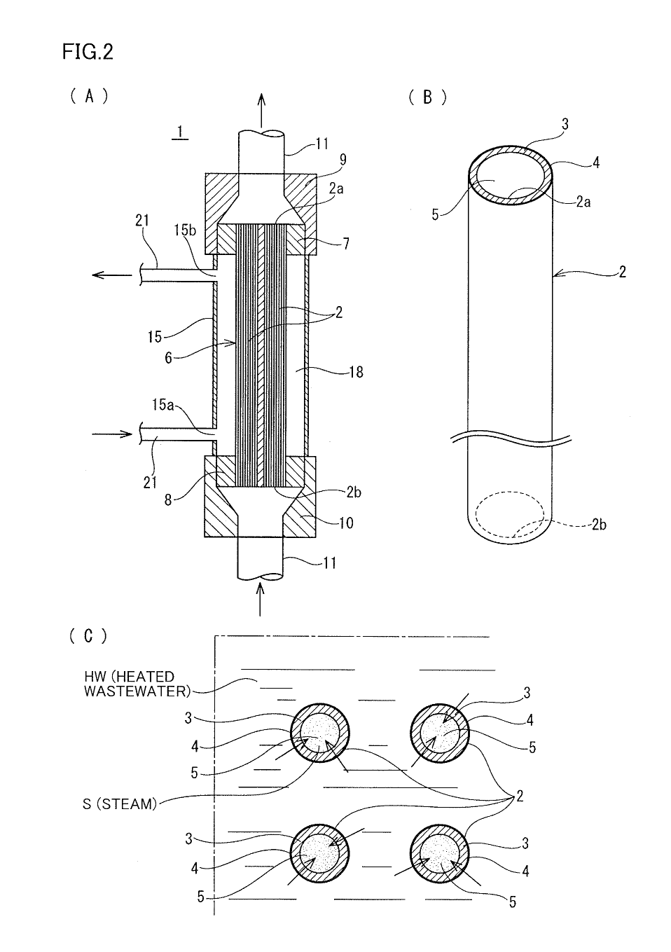

As shown in FIG. 2, membrane distillation module 1 uses hollow fiber membrane 2 made of an expanded PTFE as a hydrophobic porous membrane, and uses this hollow fiber membrane 2 as a distillation membrane.

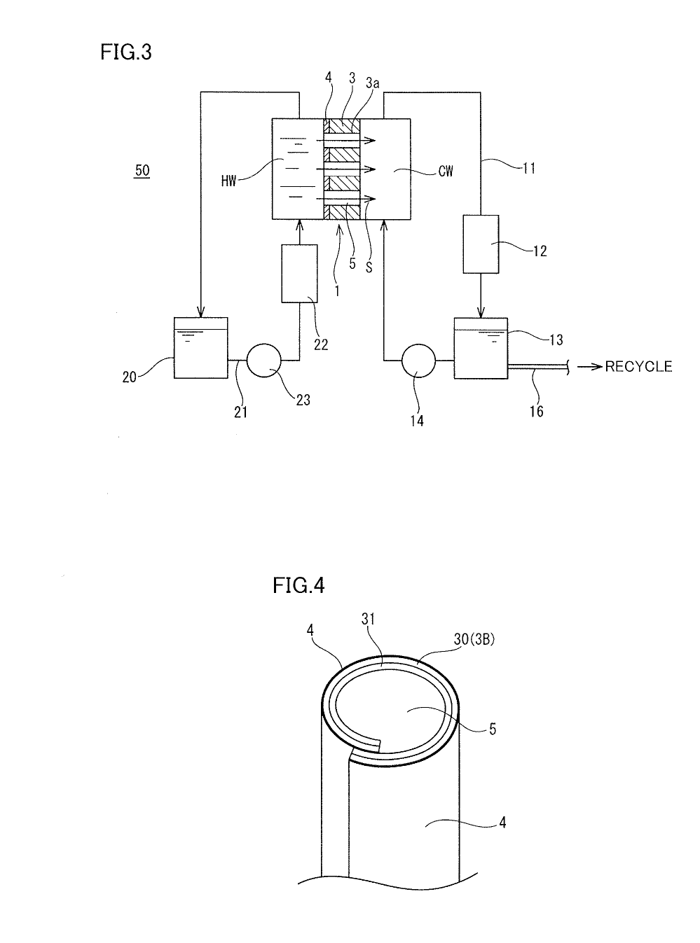

As for this hollow fiber membrane 2, the outer peripheral surface of a base membrane 3 implemented by an expanded PTFE porous membrane is impregnated with a coating liquid having dissolved therein a suitable concentration of polymer having a fluorinated alkyl side chain having the oil-repellent function in such a mode that holes 3a (shown in FIG. 3) of base membrane 3 are not closed, thereby providing an oil-repellent layer 4 held on this porous membrane. The hollow fiber membrane for membrane distillation has an average hole diameter ranging from 0.01 μm to 1 μm in order not to allow water to permeate therethrough but only allow steam to permeate therethrough.

As shown in FIG. 2 at (C) and FIG. 3, in hollow fiber membrane 2, the outer peripheral surface where oil-repellent layer 4 is provided comes into contact with heated wastewater HW, and a hollow portion 5 of hollow fiber membrane 2 shall absorb steam having permeated through the membrane. Hollow portion 5 has an inner diameter of 0.1 mm to 10 mm and an outer diameter of 1 mm to 20 mm. Hollow fiber membrane 2 has a thickness including oil-repellent layer 4 of 0.3 mm to 5 mm, an effective length of the membrane of 300 mm to 3500 mm, a porosity of 40 to 90%, and a tensile strength of 30 to 150N.

As shown in FIG. 2 at (A) and (C), membrane distillation module 1 has an assembled bundle 6 in which a plurality of hollow fiber membranes 2 are arranged at required intervals (1 mm to 20 mm). The upper and lower both ends of this assembled bundle 6 are fixed by upper and lower fixing plates 7 and 8 with upper and lower openings 2a and 2b of each hollow fiber membrane 2 being open. Caps 9 and 10 are fitted over upper and lower fixing plates 7 and 8, respectively, and the both ends of a circulative cooling pipe 11 are connected to caps 9 and 10. Circulative cooling pipe 11 communicates with the upper and lower openings of hollow portion 5 of each hollow fiber membrane 2, and hollow portion 5 serves as an annular cooling water passage.

An outer casing 15 for coupling upper and lower fixing plates 7 and 8 is attached to surround assembled bundle 6 leaving space which serves as a heated wastewater circulation 18. Openings provided on the upper and lower both sides of this outer casing 15 serve as an inlet 15a and an outlet 15b communicating with a heated wastewater circulative pipe 21.

Wastewater treatment apparatus 50 shown in FIG. 3 including membrane distillation module 1 has a cooler 12, a cooling water tank 13 and a circulative pump 14 inserted in circulative cooling pipe 11 of membrane distillation module 1. Circulative cooling pipe 11 is arranged in the atmosphere to cool steam permeated into hollow portion 5 through membrane distillation. If the fluid in circulative cooling pipe 11 has a temperature more than or equal to a required temperature, cooler 12 cools the fluid to adjust the temperature to assume the required temperature. A pipe 16 supplying cooling water to boiler supplied water tank 103 shown in FIG. 1 is coupled to cooling water tank 13. Part of the cooling water in this cooling water tank 13 is circulated to hollow portion 5 of hollow fiber membrane 2 of membrane distillation module 1, and most of the remaining part is supplied to boiler supplied water tank 103 for reuse as steam.

A wastewater reservoir 20, a circulative pump 23, and a heater 22 are inserted in wastewater circulative pipe 21 for circulating heated wastewater HW. Wastewater reservoir 20 is an atmosphere-exposed tank, and releases pressure of stored heated wastewater HW, and lowers the temperature of supplied wastewater to 100° C. or below when it exceeds 100° C.

Heated wastewater HW supplied on the outer peripheral surface of hollow fiber membrane 2 of membrane distillation module 1 is set to be held at 60° C. to less than 100° C., and to be supplied at a pressure A (30 to 300 kPa) by circulative pump 23. Treated cooling water CW supplied to hollow portion 5 of hollow fiber membrane 2 of membrane distillation module 1 is set to be held at 5° C. to 40° C., and to be supplied at a pressure B (50 to 400 kPa) by circulative pump 14. That is, heated wastewater HW on the outer peripheral side of the hollow fiber membrane for membrane distillation and cooling water CW on the hollow portion side on the inner periphery are set to have a temperature difference of 20° C. to 60° C., a relation of pressure A<pressure B, and a pressure difference of 5 to 50 kPa.

Next, the function of wastewater treatment apparatus 50 including membrane distillation module 1 will be described.

In membrane distillation module 1, only steam S produced from heated wastewater HW continuously supplied to outer casing 15 at a required pressure is allowed to permeate through hollow fiber membrane 2 to flow into hollow portion 5, but water is not, so that water does not flow into hollow portion 5. Since hollow portion 5 communicates with circulative cooling pipe 11, and cooling water CW flows therein by pump 14, permeated steam S comes into contact with cooling water CW and is liquefied to become cooling water. This cooling water CW is stored in cooling water tank 13. Cooling water CW in cooling water tank 13 is supplied to boiler supplied water tank 103 through pipe 16. Part of cooling water CW in cooling water tank 13 is circulated to hollow portion 5 of hollow fiber membrane 2 through circulative cooling pipe 11.

Since hollow fiber membrane 2 of membrane distillation module 1 has oil-repellent layer 4 disposed on the outer peripheral surface to be in contact with heated wastewater HW, an oil component is unlikely to adhere, which can reduce/prevent any adhering oil to block the holes of hollow fiber membrane 2. Thus, reduction in membrane distillation capability can be restrained/prevented.

Cooling water CW purified in membrane distillation module 1 can be purified to such an extent that an oil component, a salt component and organic matters including naphthenic acid are each contained only by 1 mg/liter or less.

In membrane distillation module 1, oil-repellent layer 4 is provided on the outer peripheral surface of hollow fiber membrane 2 to be in contact with heated wastewater HW to reduce/prevent adhesion of the oil component. However, in order to stably maintain the permeate flow rate of steam over a long period of time, it is necessary to conduct periodical cleaning.

Hollow fiber membrane 2 made of PTFE used for the present invention has excellent chemical resistance, and is subjected to chemical cleaning in order to remove an adhering oil component. As the cleaning chemical, 1 to 20% of caustic soda solution, sodium hypochlorite, hydrogen peroxide solution, or the like is used suitably. Furthermore, heated wastewater HW and cooling water CW are discharged from membrane distillation module 1 during stop of circulation of heated wastewater HW and cooling water CW, and then, dry air is blown to maintain the temperature in membrane distillation module 1 so as not to be frozen.

When wastewater treatment apparatus 50 including membrane distillation module 1 is used, the following specific functions and effects (1) to (5) are obtained.

(1) The oil component, salt component, and organic matters including naphthenic acid can be removed to reduce the oil component, salt component and organic matter to be less than 1 mg/L, respectively.

(2) By significantly removing the oil component and the organic components, scale trouble caused by organic matters in the apparatus and pipes for reheating treated water is reduced.

(3) Since the salt component can also be removed through membrane distillation, which eliminates the need for the desalination step by a hardness component removal device or an evaporator which has conventionally been required.

(4) Because of desalination, heating can be performed by reusing a general-purpose drum-type boiler used conventionally, instead of a special once-through type boiler, which enables greatly reduced equipment costs.

Adopting this drum-type boiler can reduce the amount of blow down from 20-30% by weight in the conventional case to 1-5% by weight, which can improve thermal efficiency and can reduce energy consumption. The amount of consumption of water and the discharge amount of wastewater can also be reduced.

(5) When a PTFE membrane is used for membrane distillation, the membrane has heat resistance that can be used even when the temperature of heated wastewater is 200° C., and the heated wastewater can be supplied to the membrane distillation module without cooling, which can significantly reduce heat loss. When a membrane made of ceramics is used, such a membrane has problems in crack resistance due to rapid temperature rise/fall, alkali resistance in connection with chemical cleaning, handling ability associated with weight, size, lack of flexibility, and avoidance of freezing, and economical efficiency, but the problems can be overcome by using a PTFE membrane.

A variation of a hydrophobic porous membrane for use in the membrane distillation module is shown in FIG. 4.

In this hydrophobic porous membrane, an expanded PTFE sheet is wound and wound ends are secured by sealing to obtain a tubular porous membrane serving as base membrane 30, instead of using a hollow fiber membrane. Oil-repellent layer 4 is provided on the outer peripheral surface of this base membrane 30, and a support layer 31 made of a nonwoven fabric is provided on the inner peripheral surface. Hollow portion 5 of this tubular porous membrane can have an inner diameter larger than that of hollow portion 5 of hollow fiber membrane 2.

Since other structure and functions are similar to those of the hollow fiber membrane of the above-described embodiment, description thereof is omitted.

### REFERENCE SIGNS LIST

1 membrane distillation module; 2 hollow fiber membrane; 4 oil-repellent layer; 5 hollow portion; 6 assembled bundle; 11 circulative cooling pipe; 21 circulative heated wastewater pipe; 50 wastewater treatment apparatus; HW heated wastewater; CW cooling water; S steam.

1. A wastewater treatment method for purifying heated wastewater produced when recovering bitumen from an oil sand layer by an in-situ recovery method for reuse as steam, comprising:
extracting bitumen from a heated bitumen-mixed fluid recovered by injecting high-temperature steam into said oil sand layer; and
subjecting separated heated wastewater to membrane distillation using a hydrophobic porous membrane provided in a membrane distillation module to recover treated water from which an oil component, a salt component, and an organic matter contained in said heated wastewater have been reduced/removed.

2. The wastewater treatment method according to claim 1, further comprising:
flowing said heated wastewater held at 60° C. to 200° C. on one surface side of said hydrophobic porous membrane at a pressure A by a pump; and
flowing cooling water held at 5° C. to 40° C. on the other surface side at a pressure B by a pump, wherein
a relation of pressure A<pressure B is met.

3. The wastewater treatment method according to claim 1, wherein said treated water having been subjected to said membrane distillation has such water quality that each of the oil component, the organic matter including naphthenic acid, and the salt component is contained by less than 1 mg/l.

4. The wastewater treatment method according to claim 1, further comprising:
reheating said treated water having been subjected to membrane distillation by a drum-type boiler to obtain high-temperature steam, without a distillation apparatus, such as a hardness removal device or an evaporator interposed therebetween; and
injecting the high-temperature steam into a high-viscosity oil in said oil sand layer to be reused for recovering bitumen.

5. The wastewater treatment method according to claim 2, further comprising:
discharging the heated wastewater and cooling water from said membrane distillation module during stop of circulation of said heated wastewater and cooling water; and
thereafter blowing dry air to reduce humidity to maintain the humidity in said membrane distillation module such that steam does not condensate.

6. A membrane distillation module for use in the wastewater treatment method according to claim 1, wherein an oil-repellent layer is provided at least on a surface of said hydrophobic porous membrane made of fluorine-based resin to be in contact with said heated wastewater.

7. The membrane distillation module according to claim 6, wherein a polymer having a fluorinated alkyl side chain is held in said oil-repellent layer.

8. The membrane distillation module according to claim 6, wherein said hydrophobic porous membrane is made of PTFE (polytetrafluoroethylene), PVDF (polyvinylidene difluoride), or PCTFE (polychlorotrifluoroethylene), and made of fluorine-based resin having heat resistance whose practical maximum operating temperature exceeds 100° C.

9. The membrane distillation module according to claim 6, wherein
said hydrophobic porous membrane used for said membrane distillation is implemented by one of (1) a hollow fiber membrane, (2) a tubular porous membrane obtained by winding a porous sheet and securing wound ends by sealing to represent a cylindrical shape, and (3) a bag-like composite membrane obtained by sealing, such as by heat sealing, both ends of a single porous sheet or two porous membranes laminated on both surfaces of a dissimilar material, such as a nonwoven fabric, and provided with slits of a specified width, a flow path material, such as a net, being included on the inner side of said composite membrane, and
in said hydrophobic porous membrane, a circulative path for said heated wastewater is provided on an outer peripheral surface where said oil-repellent layer is provided, and a hollow portion surrounded by an inner peripheral surface serves as a circulative path for said cooling water.

10. A wastewater treatment apparatus comprising the membrane distillation module as defined in claim 9,
a reservoir of said heated wastewater, a pump and a heater being inserted in the circulative path for said heated wastewater, said reservoir being exposed to the atmosphere to lower pressure and temperature relative to raw water of the heated wastewater, the temperature being adjusted by said heater to a required temperature, and said heated wastewater being supplied to the outer surface side of said hydrophobic porous membrane by said pump at required pressure A,
a cooler, a cooling water tank and a pump being inserted in the circulative path for said cooling water, the temperature of treated water produced from steam having permeated through said hydrophobic porous membrane being adjusted by said cooler and captured into said cooling water tank, part of the treated water stored in the cooling water tank being supplied to said circulative path by said pump for use in liquefying the steam having permeated through said hydrophobic porous membrane, and the remainder of said treated water being supplied to a pipe of a reuse system for recovering bitumen.
